(19) United States
(12) Patent Application Publication
(10) Pub. No.: US 2015/0324863 A1
(43) Pub. Date: Nov. 12, 2015

(54) ADVERTISING WITH INTERACTIONS BETWEEN A USER AND AN ADVERTISED SUBJECT MATTER

(71) Applicant: AdLyft, Inc., Arlington, VA (US)

(72) Inventor: Thurman Wayne Pugh, Arlington, VA (US)

(21) Appl. No.: 14/707,504

(22) Filed: May 8, 2015

Related U.S. Application Data
(60) Provisional application No. 61/990,892, filed on May 9, 2014.
(60) Provisional application No. 62/143,477, filed on Apr. 6, 2015.

(51) Int. Cl. G06Q 30/02; G06Q 50/00

(52) U.S. Cl. CPC G06Q 30/0269; G06Q 30/0226; G06Q 50/01

(57) ABSTRACT

Methods, devices, and computer program products for creating and presenting interactive advertisements are described herein. An interactive advertisement comprising one or more requested interactions may be created and presented to a user. An interaction may be, for example, capturing an image of a product, saying a brand name, visiting a location, or the like. The user may provide input responsive to the requested interaction, and the input may be validated. If the user successfully completes the requested interaction, the user may receive a reward or other compensation. Aspects of the methods, devices, and computer program products, such as interactive advertisements, requested interaction types, and compensation for completing a requested interaction, may be controlled or targeted based on user or advertiser preference. In some aspects, the interactive advertisement may be created by an advertiser or by an operator of an interactive advertising platform using a specially-programmed computing device.

### CROSS-REFERENCE TO RELATED APPLICATIONS

This application claims priority to U.S. Provisional Application No. 61/990,892, filed May 9, 2014, entitled “SYSTEMS AND METHODS OF ADVERTISING WITH USER-PRODUCT INTERACTION,” and U.S. Provisional Application No. 62/143,477, filed Apr. 6, 2015, and entitled “ADVERTISING WITH USER-PRODUCT INTERACTION,” the contents of each hereby incorporated by reference in their entireties for all purposes.

### FIELD

This present application generally relates to the presentation and delivery of advertising, and relates, in particular, to presentation and delivery of interactive advertising to user devices such as mobile devices.

### BACKGROUND

Advertising through conventional media, even on mobile platforms, is typically one-directional. A viewer, user, or other media consumer is shown or otherwise subjected to advertising within or between media to be consumed, with no feedback or product interaction from the consumer while the advertising is executed. Interaction with the product or service being advertised occurs after the advertisement, if it occurs at all, when the consumer is sufficiently motivated to interact with, or buy, the previously-advertised product or service. Rarely, a user may interact with an advertised product or service during presentation of an advertisement, but it is through a means different from the media carrying the advertisement. For example, a viewer may call an advertised telephone number for a deal during the advertisement's display, or a mobile application user may abandon the application to separately download a different application being advertised in the mobile application.

Electronic and mobile devices often include sensors, receivers, and displays for interacting with environments in various ways. For example, such devices may include cameras capable of image capture and transmission, GPS antenna capable of device locating and/or geolocation, accelerometers and gyroscopes capable of detecting device movement, microphones capable of sound capture, and processors for handling sensed data. Electronic and mobile devices may have significant processing capability and be relatively versatile, like mobile phones, wearable computers and smartphones, laptop and tablet computers, and personal readers and media players. A user may program and/or control the device to interact with products or services by interacting with a touchscreen and GUI and/or through specific physical controls like buttons and control wheels.

Advertising on mobile devices often includes visual or auditory one-way messaging. A user may be displayed an advertisement in a portion of a mobile application or at an interstitial point in mobile content delivery, without any possibility of interaction. Or, if a user can interact with the ad, such as by touching a touchscreen displaying the ad or pushing a button on the device to select the ad, the user does not supply any additional information or activity to the advertisement, and the simple interaction results in either the ad being dismissed or the user taken to a separate application for purchasing the advertised product or service.

### SUMMARY

The following presents a simplified summary in order to provide a basic understanding of some aspects of the disclosure. The summary is not an extensive overview of the disclosure and is not intended to identify key or critical elements or to delineate the scope of protection sought. The following summary merely presents some concepts of the disclosure in a simplified form as an introduction to the more detailed description provided below.

To overcome the problems presented above, and to overcome other challenges that will be apparent upon reading and understanding the present specification, aspects described herein are directed toward promoting interactions between a user operating a mobile device and physical objects that represent the subject matter of an advertisement, such as a product, brand, service, company, location, organization, movement, philosophy, candidate, or any other subject for which awareness is sought. According to a first aspect, a method includes displaying an interactive advertisement to a user. The advertisement may include one or more interactions with a subject matter, potentially associated with the same subject matter being advertised (e.g. an interaction with a can of a soft drink, the brand of which is being advertised in the advertisement) or a different subject matter (e.g. an interaction occurring at a retail location of a fast-food restaurant because of a cross-promotion with the brand of soft drink). The user may then execute, achieve, or perform the interaction from the advertisement and submits the execution, achievement, or performance for verification. For example, the interaction may be an action with a product, and a user can input the action through a mobile communications device or a computer. Rewarding the user may result from successful verification of the execution of the interaction, achievement of the interaction, or performance of the interaction. Example aspects may also display the reward with the advertisement and perform alternative actions based on failed or incomplete verification. Verification may be binary or multi-factored and graduated, with rewards varying the same way. Example methods and embodiments further include input processing hardware/software to verify that a requested interaction occurred.

These and additional aspects will be appreciated with the benefit of the disclosures discussed in further detail below.

### BRIEF DESCRIPTIONS OF THE DRAWINGS

The details of these and other aspects of the disclosure are set forth in the accompanying drawings and description below. Other features and advantages of aspects of the disclosure will be apparent from the description and figures.

FIG. 1 depicts an example of an implementation of a network for delivering interactive advertisements.

FIG. 2 depicts an example of an implementation of a mobile device according to one or more aspects described herein.

FIG. 3 depicts a flow chart of example method steps of interactive advertising.

FIGS. 4A, 4B, 4C, 4D, 4E, and 4F depict illustrations of an example graphical user interface for performing example methods according to one or more aspects described herein.

FIG. 5 depicts example methods of the disclosure in the context of a user interface for creating interactive advertisements.

FIGS. 6A, 6B, 6C, and 6D depict example methods of the disclosure in the context of user interface elements for creating interactive advertisements.

FIGS. 7A and 7B depict examples of interactive advertisements created using one or more example methods of the disclosure.

FIG. 8 depicts example user interface elements for assigning values to rewards in applications according to one or more example methods of the disclosure.

FIG. 9 depicts an exemplary computer network for performing one or more of the aspects described herein.

FIG. 10 depicts exemplary aspects of a computing device in the computing network of FIG. 9 for performing one or more of the aspects described herein.

### DETAILED DESCRIPTION

In the following description of the various embodiments, reference is made to the accompanying drawings identified above and which form a part hereof, and in which is shown by way of illustration various embodiments in which aspects described herein may be practiced. It is to be understood that other embodiments may be utilized and structural and functional modifications may be made without departing from the scope described herein. Various aspects are capable of other embodiments and of being practiced or being carried out in various different ways. It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “mounted,” “connected,” “coupled,” “positioned,” “engaged” and similar terms, is meant to include both direct and indirect mounting, connecting, coupling, positioning and engaging. In addition a set refers to a collection of one or more elements. Furthermore computer-readable media as used in this disclosure includes all non-transitory computer-readable media and excludes transitory computer readable media such as propagating signals. It should also be noted that the structures and operations discussed below may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually or sequentially, so as to provide looping or other sequences of operations than those described below. It should be presumed that any embodiment having features and functionality described below, in any workable combination, falls within the scope of example aspects.

Most user interaction with advertising, particularly on smaller user electronics providing other communications functionalities, is limited to determining how to dismiss the advertisement. For example, a user upon being presented with an advertisement primarily looks for an “x” or “dismiss” box or “skip” dialogue in order to clear the advertisement as soon as possible. Many “interactions” with the advertising presented are accidental misclicks trying to find these clearing options. Many users may turn off a display, turn down volume, or deactivate or put away their devices when presented with advertising, with an intention that they may return to their device after the advertising is done.

In other adverting regimes, such as those delivering user rewards for code redemption, or social media interactions with a product, any interaction with a product or service may occur well outside of, temporally and/or spatially, any advertisement, which limits advertiser's abilities to control the user experience and verify actual user interaction with the advertised subject matter.

To overcome these newly-recognized problems, users can be rewarded for actual interaction with an advertised subject matter, such as a product, service, brand, or the like, or a location, event, or other object associated with the advertised subject matter, even on mobile platforms, to incentivize meaningful user interactions with advertised subject matter.

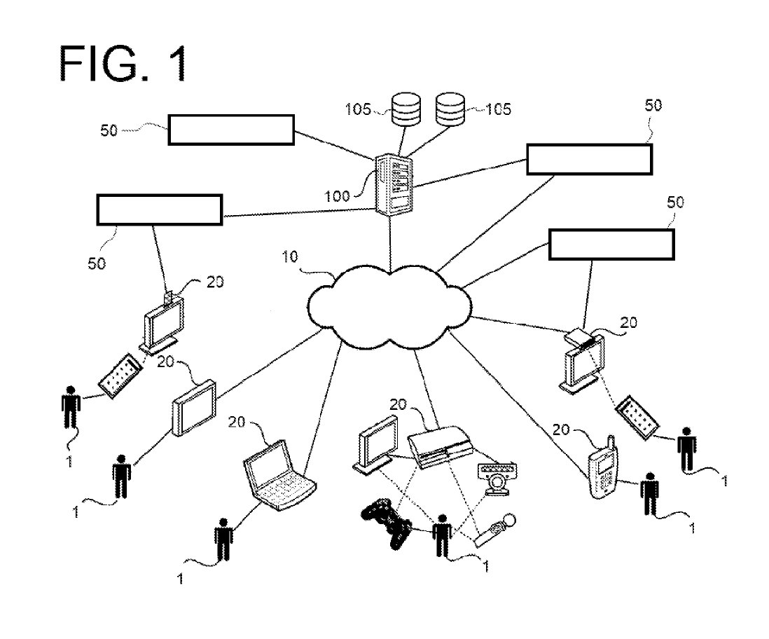

FIG. 1 is an illustration of an example network useable to deliver interactive advertising content. As shown in FIG. 1, a network 10 provides communicative connection among several different user devices 20. For example, network 10 could be the Internet or another TCP/IP protocol network such as a WAN or LAN or intranet, or network 10 could be a wireless cell network operating on CDMA, GSM, LTE, Wi-Fi, Bluetooth, GPS, near field communications, etc. Network 10 may thus be any structure or protocol that allows meaningful communication between devices 20 and/or other information sources.

One or more content providers 50 connect to one or more user devices 20, either directly or via network 10 or another network. Providers 50 can be any content, media, functionality, software, and/or operations providers for user devices 20. For example, providers 50 may include mobile software developers with server backends and/or access portals for downloading and running software or streaming media on user devices 20. Providers 50 may include a network operator, such as a cellphone and mobile data carrier operating network 10 and controlling access rights of user devices 20 as well as general operation of network 10. Providers 50 may be application storefronts providing search, download, operations connectivity, updating, or the like for apps on devices 20. Providers 50 may be a website or ftp server offering downloadable files or other content that may be displayed or otherwise consumed through user devices 20. Although providers 50 are mostly shown clustered around network 10 for connectivity to user devices 20, it is understood that there may be any direct or indirect connection between any provider 50 and any user device 20.

Content providers 50 may include some form of sponsored content in their offerings to user devices 20 and, ultimately, users 1 operating user devices 20 and consuming content from providers 50. The sponsored content may be of any nature, including direct advertisements, product placement, sponsorships, etc. Sponsored content may be provided with or in any content, including applications, media, files, etc., or may be provided separately, such as an advertisement prerequisite to accessing content from providers 50.

An interactive advertising provider 100 provides interactive sponsored content to user devices 20 and ultimately users 1, potentially through providers 50 and/or network 10. For example, the interactive advertising provider 100 may be connected to several different user devices 20 through a network 10. Additionally or alternatively, the interactive advertising provider 100 may be connected directly to a content provider 50, who will transmit interactive sponsored content to user devices 20. The interactive advertising provider 100 may connect directly to a user device 20. This flexibility in networking can achieve a variety of different sponsored content treatments. For example, user devices 20 may directly receive sponsored content from the interactive advertising provider 100 or as part of an application or functionality provided from content provider 50, directly from content provider 50 or via a network 10. In this way content providers 50 and/or network 10 may play a role in transmitting sponsored content from the interactive advertising provider 100.

As shown in FIG. 1, the interactive advertising provider 100 may be connected to one or more advertising databases 105, which may store interactive sponsored content and/or user or advertiser profile data for intelligent advertising targeting or behavior. The advertising databases 105 may be operated by or associated with a third-party advertiser who may provide at least some content for the interactive advertising provider 100 to format into and provide as interactive sponsored content. In this way the interactive advertising provider 100 may be operated and/or controlled by a limited operator who may accept or format advertising data, user profile, targeting information, or the like from one or more third-party advertisers and/or product owners. Alternatively, the interactive advertising provider 100 may be an enterprise level operator with one or more stored databases of created or received interactive advertising content in advertising databases 105, as well as profile and targeting information.

A user device 20 may be any electronic device, such as a mobile device, capable of performing an advertisement, accepting input of interaction by a user 1 with an advertised subject matter, and operating based on that input. Examples of user devices 20 may include wearable computers, smartphones, tablets, media players, GPS units, IPTVs, desktop or notebook computers, personal tracking accessories, media and gaming consoles, or the like.

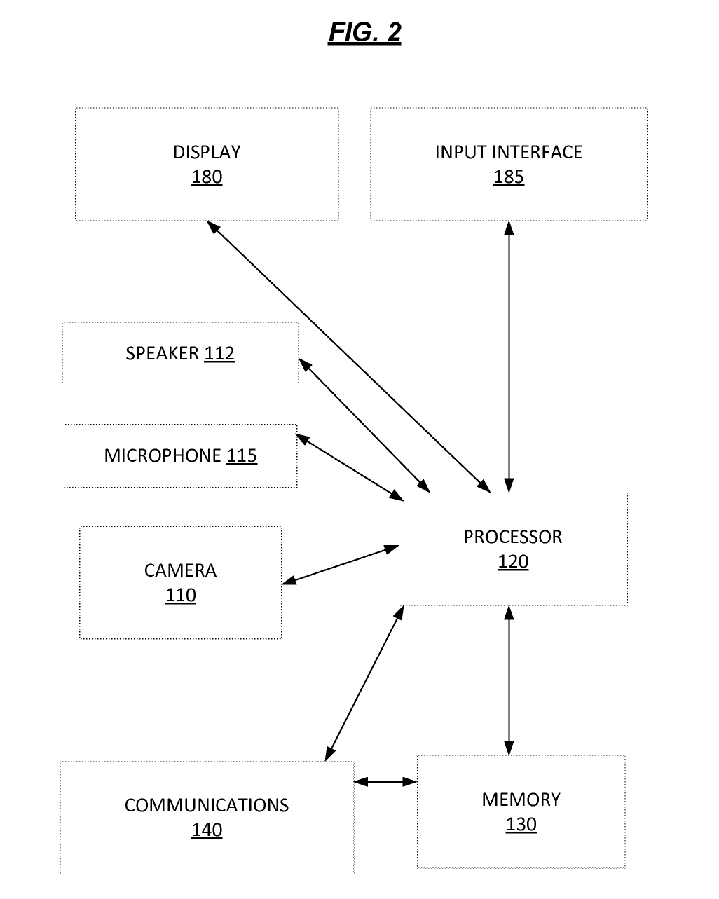

FIG. 2 depicts a schematic of an example user device 20 illustrating components that may permit performance of interactive advertising. For example, a user device 20 may include a camera 110 including a lens and image sensor, a speaker 112, a microphone 115, a computer processor 120, persistent and/or transient storage 130, display screen 180 (which may comprise a touchscreen or other input reception device or component), input interface 185 for interfacing with one or more input devices, systems, sensors, or the like, and/or communications interface 140. Although elements are shown within a single device 20, it is understood that any element may be separate and connected through appropriate communications such as an external bus or wired or wireless connection.

The processor 120 may include one or more computer processors connected to and specially programmed or otherwise configured to control the various elements of example user device 20. The processor 120 may further be configured to execute example methods, including performing interactive advertisements and reacting in accordance with user input. User input may be received via the input interface 185 (which may include one or more input sensors), the microphone 115, the display screen 180, and.

The persistent and/or transient storage 130 may be a dedicated data storage drive or device or may be a partition of a general data store in which interactive advertising and/or raw data can be saved, stored, located, or the like. The storage 130 may be, for example, random access memory (RAM), read only memory (ROM), programmable read only memory (PROM), erasable programmable read only memory (EPROM), electronically erasable programmable read only memory (EEPROM), flash memory, a hard disk, a processor cache, optical media, other computer readable media, or the like.

The camera 110 may include one or more lenses controlled by lens actuators that move the lenses among different positions to focus the lenses for capturing optical data. Similarly, the camera 110 may adjust focus automatically or in response to user input defining focus locations in the scene being captured. The camera 110 may include image sensor elements such as a charge coupled device (CCD) array, a photodiode array, or any other image sensing device that receives light, potentially via the lens, and generates image data in response to the received light. The camera 110 may be further configured to obtain or adjust image information such as focus, zoom, white balance, exposure, saturation, and/or other image functions. The obtaining or adjusting by the camera 110 may be automatic (e.g. not in response to user input) or responsive to user input received at the user device 20 or other computing device.

The speaker 112 may include any auditory transmission device capable of audio performance of an interactive advertisement or a component thereof. The microphone 115 may include any auditory transmission and/or reception device capable of audio performance of an interactive advertisement and user input with regard to the interactive advertisement. For example, microphone 115 may include an embedded speaker and/or an embedded induction microphone in a mobile device.

The display 180 may be a screen, viewfinder, monitor, or any other device capable of visually displaying an interactive advertisement. As discussed above, the display 180 may also comprise an input device or component configured to receive user input, including input received with regard to the advertisement. For example, display 180 may be a touchscreen, LCD monitor, CRT monitor, projector, or the like.

The input interface 185 may provide input information with regard to one or more components discussed above, such as the display 180, or with regard to the user device 20 as a whole. For example, if the display 180 is a touchscreen device or other component capable of receiving touch-based input, or the user device 20 is configure to receive touch-based input, input may be received on or via input interface 185 from one or more multi- or single-touch sensors capable of detecting finger or stylus touch, pressure, movement, or the like may be embedded in the display 180 or otherwise located on or within the device 20 to receive the input. These multi- or single-touch sensors may be capacitive sensors. In another example, sensors which may input data via the input interface 185 may include an accelerometer, such as a magnetized compass accelerometer with associated hardware or software or the like, capable of determining device orientation and/or movement. As another example, sensors communicating via the input interface 185 may include a button, keyboard, an external mouse, joystick, or the like and associated hardware or software capable of controlling and determining cursor position and/or activation with respect to the display 180 during operation of the user device 20. The Additional or alternative sensors may be connected to the processor 120, including sensors connected via the input interface 185, and may be capable of deliver sensed input information to the processor 120 including cursor or contact position, duration, numerosity, pressure, movement speed, or the like. For example, sensors may provide communicative data received via a radio frequency (RF) sensor, near-field communication (NFC) sensor, wireless radio transceivers such as Bluetooth or Bluetooth Low Energy or the like, and/or other protocols, systems, or the like. Of course, other examples may be possible.

The processor 120 may be any computer processor, including a processor associated with processor cache, transient memory, video buffer, or the like, specially configured or specially programmed to process interactive advertising content and the same through user device 20. The processor 120 may also be configured or programmed to process any input to device 20, including optical or audio information or signals received via microphone 115 and/or camera 110, including information or signals received as inputs indicative of interaction between a user and an advertised subject matter. The processor 120 may also be configured to store or retrieve results, signals, information, data, or the like in the memory 130, including processing instructions stored in a non-transitory format. The processor 120 may also receive sensor information from sensors via an input interface 185 and process the same as an interaction between a user and an advertised subject matter. As discussed above, the sensor information may include touch information, cursor information, textual information input via keyboard or other text-entry device, image information, auditory information, or the like. The processor 120 may further include software or configured hardware, or be configured to access, signal, run, operate, and/or execute software or configured hardware, that allows for execution of example methods discussed below.

The user device 20 may further include a communications interface 140 for external wired or wireless communication. For example, communications interface 140 may be an antenna configured to transmit and receive data on radio bands, such as code division multiple access (CDMA) bands, a Wi-Fi antenna, a near field communications (NFC) transmitter/receiver, a GPS receiver, an external serial port or external disk drive or the like. The processor 120 may provide data from the storage 130, data from the camera 110, data received via input interface 185, data from the microphone 115 or the like, to external devices or systems through communications interface 140. Additionally, the user device 20 or devices or components thereof may receive data or signals indicative of data via the communications interface 140, as well as receive advertising content from providers through communications interface 140. In some aspects, communications interface 140 may function as another input source for user interactions.

Although networked elements and functionalities of example embodiment device 20 are shown in FIG. 2 as individual components with specific groupings and subcomponents, it is understood that these elements may be co-located in a single device having adequately differentiated data storage and/or file systems and processing configurations. Alternatively, the elements shown in FIG. 2 may be remote and plural, with functionality shared across several pieces of hardware, software, or firmware, each communicatively connected to provide data transfer and analysis, if, for example, more resources or better logistics are available in distinct locations. Given the variety of example functions described herein, example user devices 20 may be structured in a variety of ways to provide desired functionality. Other divisions and/or omissions of structures and functionalities among any number of separate modules, processors, and/or servers may be used according to one or more aspects described herein. FIG. 3 depicts an exemplary flow chart illustrating an example method from a vantage of a first user operating a user device, such as the user device 20 depicted in FIG. 1. As shown in FIG. 3, a user of a device is presented with an interactive advertisement in step 300. The interactive advertisement may be an advertisement for a product (including physical or virtual products), brand, service, philosophy, conglomerate, candidate, non-profit group, or any subject matter for which user awareness is sought. The advertisement may be presented at any desired time, either as a stand-alone ad or in an embedded or contextual manner within other functionality of the device. For example, if the user device is a portable media player streaming content such as a movie or television program, interactive advertisements may be displayed in step 300 at commercial or act breaks. As another example, if the user device is a video game console or mobile device on which gaming applications are installed, the interactive advertisements may be presented within the context of the game in step 300. This may include presented in the interactive advertisement as associated with an opportunity to purchase or acquire objects to be used in the enjoyment of the game, such as in-game reward options or power ups.

As another example, the user device may be a wearable computer displaying news articles or premium websites, the interactive advertisement may be presented in step 300 as a notification, such as an audio notification, of a paywall or other access prompt. As another example of a user device and functionality, the user device may be a tablet computer running a downloaded or installed application, and the interactive advertisement may be included as a component of an in-app currency screen within the application, or as a component of a warning or indication of an option, feature, or functionality that may be unlockable or otherwise accessible after a certain amount of use of the application, elapsing of a certain amount of time, or payment of a fee.

The presentation of the interactive advertisement in step 300 may be controlled by one or more parties, including a provider of the interactive advertisement; a provider of the media, application, or other content in which the interactive advertisement is presented or embedded; a network operator; a third-party advertiser; or the like. In terms of the example system illustrated in FIG. 1, any one or more of the providers 50, the network 10, the interactive advertising provider 100, and/or the third-party retailers/databases 105 may determine the timing and nature of presentation of the interactive advertisement in step 300. Further, the presentation in step 300 may be conditioned on content of any interactive advertising content, user profile(s), which may include user demographics, purchasing tendencies, commerce history, etc., as well as several different targeting factors such as user location, active device functionality, nearby commercial and promotional activities, etc. Accordingly, a first user operating a first user device running a copy of an application may be presented with a first interactive advertisement, and a second user operating a second user device running a copy of the same application may be presented with a second interactive advertisement.

The interactive advertisement presented on the user device in step 300 may include at least one interaction goal. There are very many different possible interactions to be included, limited only by actions possible by the user and verifiable by the user device, interactive advertising provider, other providers, advertiser, a third party, or any other interested party capable of verifying the action. Several specific examples are given below.

(1) For example, in step 300, a news website accessed by a user device may block subscription content by first presenting an interactive advertisement. The interaction in the presented advertisement may be a request to use or capture a picture, image, scan, or recording of a can of a specific type of soft drink with the device to show proximity, purchase, obtainment, or the like of the can. As will be discussed below, the picture, image, scan, or recording of the can may be verified by either the user device capturing the representation of the can, or by a server operated by an interactive advertisement publisher, advertiser, or designer, or by an interactive advertising provider.

(2) For example, a game or application being played or operated on the user device may present a screen or option for purchasing in-application currency, the game or application may reach an end point, such as a loss of player lives, the game or application may reach a juncture point where a player may access a secret item, or the like. At these screens, storefronts, and/or in-application points, the user may be presented with an interactive advertisement or an option to view an interactive advertisement. The interactive advertisement may be embedded in the application or game. The interactive advertisement may comprise a interaction goal such as scanning a barcode or QR code appearing on a label on a snack product. This scanning of a barcode or QR code may be performed using a camera of the device, for example.

(3) For example, a user may request a stream of rights-managed content from a streaming content player, or a type, station, playlist, or the like of content from an application on a computer. The player device may present an audible interactive advertisement in step 300 comprising an interaction goal of scanning a barcode or QR code from a receipt, or capturing an image or other representation of the receipt. The barcode, QR code, or representation may indicate purchase of a product or service sold or offered by the entity appearing in or responsible for the content of the advertisement, such as a promotion where a code must be scanned from a receipt from a specific store, restaurant, location, geographical area, business, airport, or the like. With respect to a goal of a receipt scanned at or from a specific location or geographical area, the user device, the interactive advertising provider, or some other device or party such as a third party or advertiser may verify a certain geographical position associated with a product or device, such as verifying the location of the player device by GPS, prior to playing the stream or at a point or points in time during presentation of the stream.

(4) For example, accessing a Wi-Fi network or other communication services, such as cellular telephony services, in step 300 an interactive advertisement may be presented on the accessing device, comprising an interaction goal of recording a video or still images of an advertised automobile or logo. Successfully “capturing” video or still images of the advertised automobile or logo may allow for temporary access to the Wi-Fi network or other communication service.

The interactive advertisement presented in step 300 may include multiple interaction goals, and a user may select a single interaction goal to pursue, or perform multiple or all possible interaction goals. As discussed above, the advertised subject matter presented within the interactive advertisement, quantity of interactive advertisements or interaction goals, and specific type or types of interaction goals presented in step 300 may be based on parameters given to or calculated by the interactive advertising provider, including parameters from third-parties. Alternatively, the subject matter, quantities, goals, may be based on data or information in user profiles, or other data showing or indicating, for example advertisement penetration, type of function/application/service being performed by a user device prior to or during the presenting, or any other detectable circumstances of the user or the device. These detectable circumstances may be examined, for example, to optimize targeting and/or select an interaction goal or interaction goals most likely to entice an interaction.

In step 310, the user may perform one or more of the interactions presented in the interactive advertisement, and may input indicating completion or performance of the interaction, or cause data or input indicating completion or performance of the interaction to be inputted. There are very many different possible interactions deliverable in step 300 and inputtable in step 310, depending on the type of user device used. For example, in response to an interaction goal requesting a user to input a code or other input responsive to a prompt by speaking the code or input, a user may speak the code or other input into a microphone of a device, including the presenting device. As another example, in step 310 a user may scan a radio-frequency ID (RFID) tag, or other like tag, on an advertised product with a capable transceiver, near-field communications antenna, or other like device located on or coupled to the device. As another example, a user may allow a GPS coordinate input by the user or derived from determining the position of the user or the device to be verified by the device in step 310. Another example may be that, in response to a prompt in an interactive advertisement, a user may take a picture or video of a requested product with a camera on the device in step 310. Another example may be that a user may perform a requested action with the user device and product that is sensed by an accelerometer in the device in step 310, such as moving the user device in one or more directions or dimensions such that the path of movement forms a shape or logo (e.g. move a device in a capital “M” shape or the like), or mimicry of an action (e.g. moving the device as if curling a dumbbell or lifting a kettlebell).

The inputting in step 310 may occur contemporaneously with the presentation of the interactive advertisement in step 300. In some aspects, inputting in step 310 may be a way to clear the display of the interactive advertisement, or remove the interactive advertisement from the display, return the device to the pre-presentation state, or the like. Inputting in step 310 may also be performed at a time other than the presenting in step 300. For example, the inputting in step 310 may in some situations be overridden or delayed to a later time following verification and rewarding. For example, a user may be presented with a “scan later” or “perform later” option in step 310, which may be selected and satisfy verification and rewarding in step 320 and step 330, discussed below. Where delaying or overriding is permitted as successful input in step 310, it may be under certain circumstances, such as when a malfunction or limited connectivity is determined. Alternatively, delayed input may be permitted a limited number of times, such as only once until the delayed action is performed and verified at the later time.

In some aspects, the user may be able to dismiss the interactive advertisement from the display or otherwise return the device to a pre-advertisement state, and one or more interaction goals may remain available for later input. For example, the user may be playing a game on the user device and may be prompted to purchase or acquire one or more units of an in-application currency. The user may be able to purchase the currency using “real” money, or the user may be able to receive in-application currency as a reward for completing an interaction goal, such as speaking the word “marmalade” so that the sound may be captured by the microphone of the device. The user may wish to not have to exchange “real” money for the in-application currency, but the user may be in a location where speaking the word “marmalade” may not be appropriate or may be potentially embarrassing. For example, the user may be in a meeting, riding in public transportation, in bed next to a sleeping significant other, or the like. The user may be able to dismiss the “marmalade” interactive advertisement and return to it at a later time or location when more appropriate or less embarrassing.

In step 320, the input from the user may be verified. This may include comparing the input or signals or data indicative of the input against a predetermined acceptable response to the interaction goal requested in the interactive advertisement presented in step 300. Using the “marmalade” example discussed above, a signal or signals indicating the sounds uttered by the user may be compared with a signal or signals corresponding to a spoken utterance of the word “marmalade” to determine if the user has uttered the word “marmalade” and not the word “marshmallow.”

Verification in step 320 may also assure that a user has actually interacted with an advertised subject matter in a requested manner. Verification may take many forms, based on the nature of an interactive advertisement, nature of interaction requested, or nature of subject matter. Verification may include not only matching input against in-ad request, but also determining a degree of fit between input and in-ad request, confirming that the input is real and non-duplicative, and/or determining system-software integrity of the presenting step 300, input step 310, verifying step 320, and rewarding step 330 to avoid other spoofing, shorting, or other undesired manipulation of example methods that may avoid desired interactions.

For example, an interactive ad presented in step 300 may request scanning of a QR code printed on an interior of several advertised snack wrappers, and the user in step 310 may use a QR code reader on the user device to read or scan a QR code on the inside of one or more matching wrappers. In step 320, the scanned QR code may be compared against a known content or representation of the requested QR code, such as in a database of acceptable QR code data or against general expected QR parameters. Additionally or alternatively, in step 320, the scanned QR code may be compared, in appearance or extracted content, against a list of previously-scanned QR codes, either by the same device or against a universal database of all users' scans, to determine if the scanned QR code is unique. In step 320, the input QR code may be verified as “real” or responsive to the interaction goal from the interactive advertisement by assuring that the QR code was read or scanned by a verified QR application/functionality on the user device that operated a camera on the device to capture the code. For example in step 320, software or hardware may be configured to ensure a user is not presenting a fake or downloaded picture of a QR code as input. In step 320, the input QR code may be image processed to ensure it is directly from a real interior of a snack wrapper and not a capture of a screen or other reproduction. This image processing may include, for example, looking at image data related to the exposure settings and comparing or examining portions of the captured image for data indicative of an interior of a snack wrapper, such as color, luminesce, contrast, brightness, reflectivity, refractivity, or the like. In some aspects, a QR code may not be used, and a barcode or other machine or human readable code, marker, or the like may be used. In some aspects, the marker may not be visually perceptible to the user and may be perceptible to the sensor or sensors of the user device.

Using a different example, an interactive advertisement presented in step 300 may request a picture of a brand logo from any number of different clothing articles, and a user in step 310 may use a camera on user device to capture an image of the logo on a shirt. In step 320, the captured image may be processed to extract and identify the logo from the image and compare calculated parameters regarding the extracted logo against expected parameters. A determination may be made as to the veracity of the extracted logo by determining the comparison exceeds a threshold value. Accordingly, different types of captured images that comprise the brand logo, or different articles of clothing having the logo, may be verified as accurate in step 320. Additionally or alternatively, in step 320, the image may be compared against previously input pictures by the user or a larger population to verify that the picture is unique and/or comprising a valid representation of the logo. In step 320, the process of capturing the image in step 310 may be verified or controlled to avoid a user “faking” the capturing process, and/or the photo itself may be image processed to assure veracity.

Using a different example, an interactive advertisement presented on a user device in step 300 may request at least a portion of a song or jingle—associated with an advertised subject matter or itself the subject matter—be played or recorded as input, such as by humming the notes G3-E4-C4. The user may input audio through the device's microphone in step 310. In step 320, the input audio may be processed and compared against expected input parameters. One or more points in or portions of the audio may be processed and compared against verified parameters. For example, in the case the user hums a melody, a simple approximation of the relative note values and timing extracted from the humming may be compared against true, actual, desired, or requested relative notes and timing, and agreement between the input and actual, true, desired or requested note values and timing may be determined. In some aspects, this comparison is performed with respect to a threshold of permissible deviation.

Although machine, or system-software, verification may be localized to step 320 to ensure reliable, real inputs are accepted, performing verification and other safeguards may be present throughout step 300-step 330. For example, an operating system of the user device may permit software running thereon to validate interaction goals, actions, and inputs by a user as true or acceptable or permissible or valid. For example, an operating system on a laptop computer may permit a software application presenting the interactive advertisement in step 300 to also directly control a sensor receiving the input responsive to interaction in step 310, in order to assure fake, invalid, improper, unacceptable, or false inputs are not received or used in step 310 or step 320.

In step 320, a user device may be instructed or controlled to apply one or more other verifying actions. For example, if a presented interactive advertisement in step 300 requests a user capture an image of a soft drink can with the user device, in step 320 the input image of the can be verified with a timestamp, such as an operating-system based timestamp, or other data known to or available to the user device, the provider, the interactive advertising provider, the application developer, one or more third-parties, the network provider, or the like, such as modification data showing fidelity. For example, the interactive advertisement may request the image be captured at a particular distance or zoom, and a size and resolution of the can in a captured image can be processed against expected can sizes for the distance and resolution. User interfaces may be included in the interactive advertisement, application, software development kit, application programming interface, or the like to provide the user appropriate instruction regarding how to capture the image or other input.

Continuing with the soft drink can example, during the inputting in step 310, the user device may take actions to establish “realness” of the soft drink can in step 320. As one example, image recognition analysis may be performed to determine the contents of an image. As another example, the device may capture several images, record video, or the like, of the can being captured by the user. The images and/or video may be captured at known frequencies in order to detect a screen flicker, tracking, or other indicia indicating that the picture is not of the actual product but of a screen or monitor bearing an image of the soft drink can. Or, for example, the device may take several exposures with varying exposure, focus, and/or zoom. For example, for a real, three-dimensional (3-D) object, varying exposure, focus, and zoom may result in captures of a 3-D object that differ from each other. Along an edge of an object, varying focus may have different effects on different sides of the edge in a 3-D space. The can or its edges may blur/sharpen differently than the background at different foci. Varying focus could have subtler, perhaps different, effects across the curved face of the can in 3D space. In comparison, a flat object, such as a screen or print-out of the can, exposure, focus, or zoom variation may be uniform from exposure to exposure, and no discontinuities may be detected on edges or a face of the can. By taking multiple exposures with varying properties and comparing them, particularly at expected variation points like edges or known curves in a product like on a can face, in step 320 a user device can take additional actions to verify actual or desired interaction.

In step 320, some aspects may accept a bypass, override, or delay option input in step 310 as a verified input. For example, one option in an interactive advertisement may be a delaying option input control allowing a user to “submit logo picture later.” In some aspects, such as those discussed above where the user may not be allowed to return to a pre-presentation state until the interactive advertisement interaction goal is performed, selecting this option may be verified as fully or partially matching input in step 310 and rewarded accordingly (e.g. the user may be permitted to return to the pre-presentation application state). Additional requirements may be required for future uses of the delaying option input control for such an option to be successfully verified in step 320. Tracking and controlling of these options may be performed on the local user device or at a network level, with appropriate verification controls at any location.

In step 330, a reward may be granted on a successful interaction. A successful interaction may include presentation of an interactive advertisement in step 300 featuring at least one requested interaction, a user interacting with the advertised subject matter and submitting data or signals indicative of the interaction as input into the device in step 310, and verifying the input satisfies the requested interaction in step 320. The rewarding in step 330 may occur potentially near-simultaneously with the input of the interaction in step 310 and verification of the same in step 320.

A large number of different rewards may be granted in step 330. For example, the reward in step 330 may be access to premium or subscription content, and further payment may not be needed. As another example, the reward in step 330 may be removal of the interactive advertisement presented in step 300. The reward in step 330 may be new features or functionality, such as new in-game lives, power-ups, shortcuts, objects or the like. As another example, the reward may be enabling access to requested streaming or downloadable media that is otherwise rights-controlled. The reward in step 330 may be addition of credits or loyalty awards to an account associated with the user. Another example may be that the reward in step 330 may be the advertised product or service, coupons, discounts, or additional promotional benefits for related products or services.

The reward in step 330 may vary based on the nature of the interactive advertisement presented in step 300 and/or verification in step 320. For example, rewards may scale with a quantity and/or quality of interactions submitted in step 310. For example, where a plurality of different potential interactions are presented in step 300, a user may receive greater rewards in step 330 for completing multiple interactions as opposed to a single interaction, or for completing an interaction with a particularly expensive or otherwise desired advertised subject matter.

Additionally or alternatively, rewards may differ in quality or quantity based on interactions submitted in step 310. For example, a submitted interaction in step 310 that falls close to a verification threshold or has suspected veracity problems as detected in step 320 may be rewarded with only a discount or an abbreviation of advertisement display, whereas a submitted interaction in step 310 that fully clears a verification threshold or has no authentication flaws may receive a reward or product without further payment or may be rewarded with immediate advertisement removal. Thus, the reward in step 330 may be in itself a mini-game, with better interaction(s) in step 310 resulting in better compensation.

In step 325, an alternate behavior is executed based on an unsuccessful interaction. For example, a user may fail to interact with an advertised subject matter or submit input in step 310, or verification of the input may not match the request in step 320. In step 325, the user may receive no reward, may be redirected to interact with a same or subject matter through a same advertisement, and/or may be shown a new advertisement, essentially repeating from step 300. If not presented with a reward in step 325 but subjected to similar advertising content over time in step 300, a user may prepare for future advertising requests by purchasing or acquiring an advertised subject matter necessary to satisfy an interaction request or otherwise preparing themselves for direct interaction with a advertised subject matter in the event of future advertising of the same nature.

A user failing an interaction in step 325 or receiving a partially successful verification in step 320 may receive an incomplete reward, no reward, or punishment. For example, use of a bypass option or verification of an image with suspicious 3-D or flickering properties or submission of a minimum number of interactions may be a partially successful verification in step 320. The failed or not completely successful submission may be punished in any way, including by a warning, losing credits, discounts, rewards, in-game perks, etc., reduced rewards over time, locking the user out of an application or functionality on the user device temporarily or permanently, subjecting the user to a timer or grace period for full verification before punishments are enforced immediately or gradually, or the like.

According to some aspects, steps depicted in FIG. 3 may be varied, spread apart, repeated, reversed, placed in any order, or the like when appropriate. For example, step 300, step 310 and step 320 may be looped a number of times with different interaction goals. As one example, an advertisement displayed as challenge to unlock application functionality in step 300 may request scanning a UPC label of a specific product, such as a cool ice rehydration beverage, and the user may input an appropriate UPC scan in step 320. Step 300 may then be repeated near instantaneously with a second stage, requesting the user sweep their mobile device like a broom as if they are a sweeper in the game of curling while holding the product. The user device may verify the sweeping motion with an accelerometer and/or camera in step 320. Based on successfully completed interactions in step 320, a reward in step 330 may then be granted. Other repetitions, alterations, inversions, and sequencing of example methods are possible.

Example methods may be implemented, at least in part, in user device hardware, software, firmware or any combination thereof. For example, various aspects, such as interactive advertisement display and/or interaction input processing and verification, may be executed within one or more processors, including one or more microprocessors, digital signal processors, application specific integrated circuits, field programmable gate arrays, or any other equivalent integrated or discrete logic circuitry, as well as any combinations of such components. A control unit including such hardware may also execute or control example methods. Any hardware, software, and/or firmware may be configured within a single device or networked across separate devices to support the various operations and functions described herein. Actions and functionality of example methods and units, modules, or components of example embodiments may be implemented together or separately as discrete but interoperable logic devices.

Example aspects may be implemented through relatively direct and simple interfaces on user devices to provide easy understanding of a requested interaction and input of the same by the user. For example, an interaction presented on a user device may include a simplified image of the interaction and explanatory phrase of the same, along with a single button for controlling a sensor on the device to capture input of the user interaction with a product in the requested manner. For example, a relatively simple picture icon next to an advertised product may be presented along with a viewfinder display and button for taking a picture of the product or another requested interaction with the product. Additionally or alternatively, a graphical user interface of the interactive advertisement display may include options to see additional interaction requests, select a particular interaction, and/or provide further explanation of an interaction.

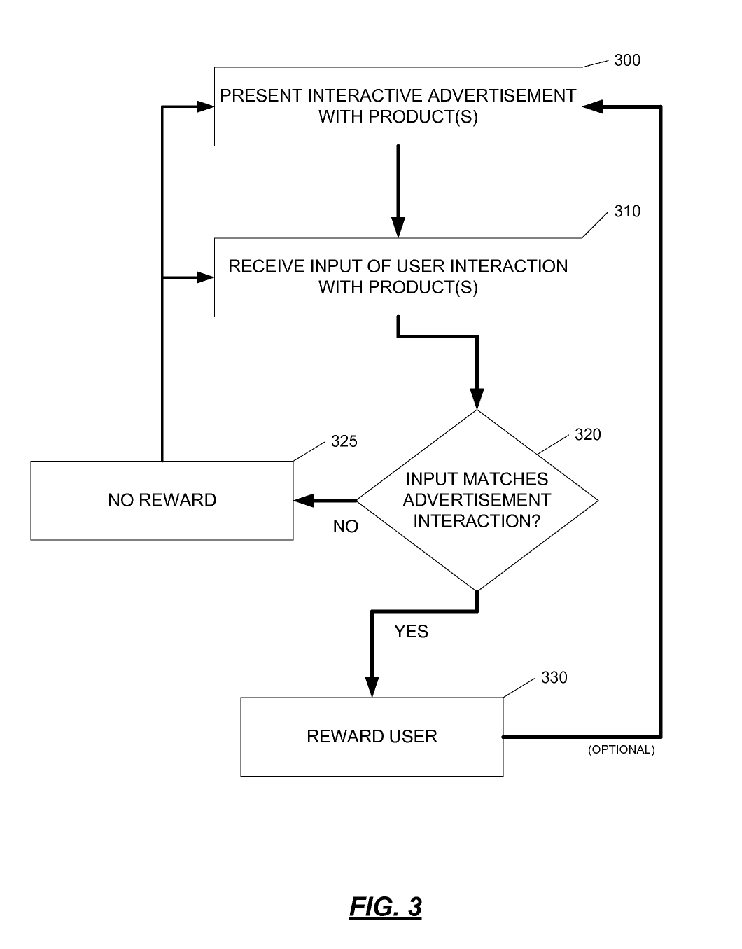

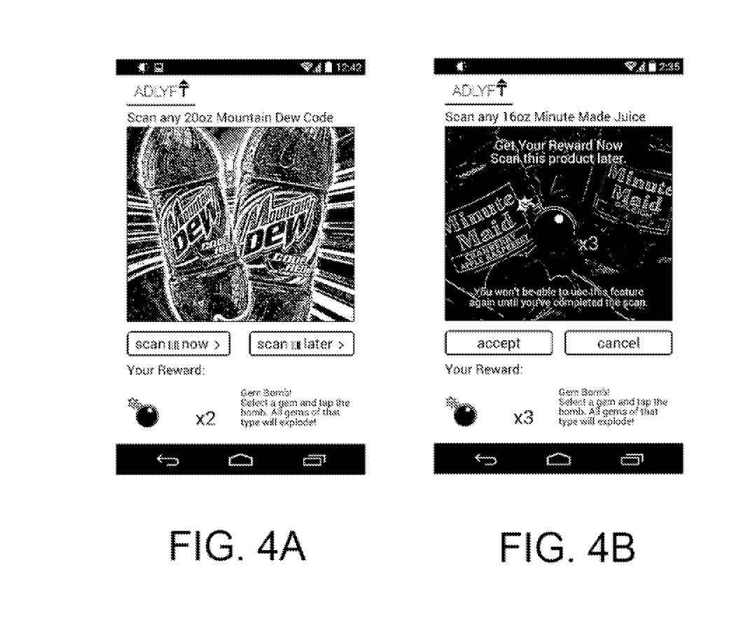

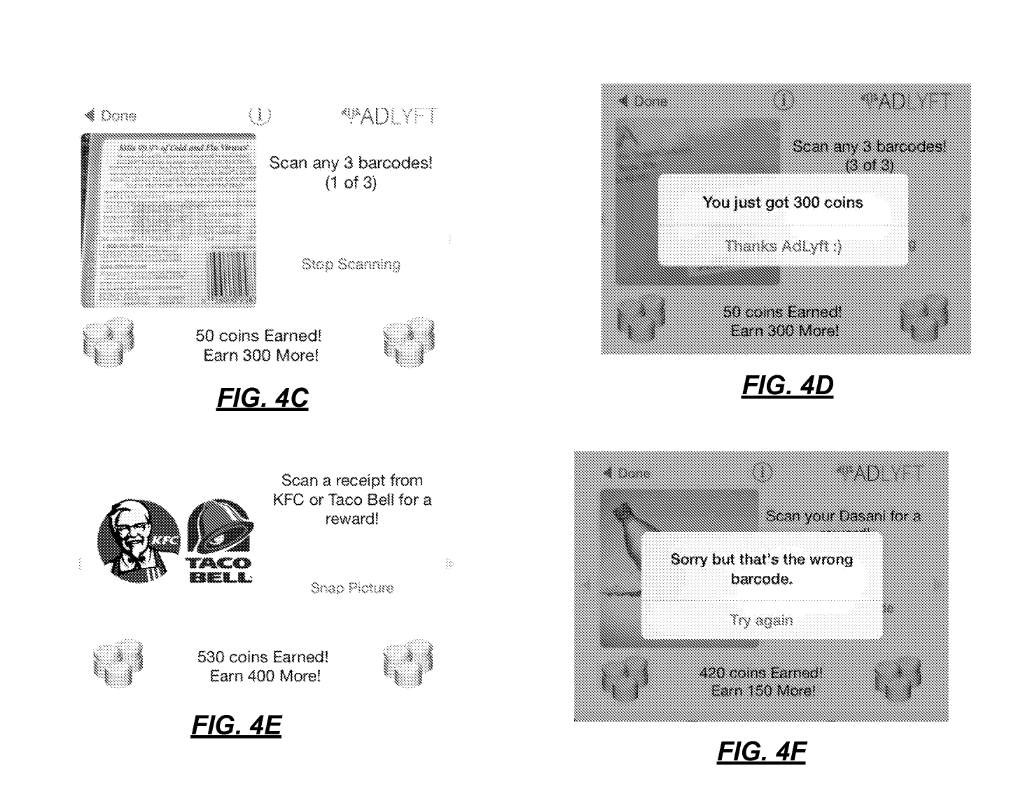

FIGS. 4A and 4B depict example graphical user interfaces showing how a user may be presented and interact with a product and advertisement in step 300 and step 310. As shown in FIG. 4A, an interactive advertisement in step 300 may be shown to a user in a game to receive a displayed award. After interacting by appropriately scanning the product, the screen in FIG. 4A may disappear and the game result with appropriate functionality unlocked in step 320 and step 330. If a user elects to scan later in step 310 through the interface of FIG. 4A, the action may be verified through the interface of FIG. 4B. Of course, any number of different modular advertisements may be displayed in FIG. 4A, with any number of different input options and rewards, than what is shown in FIGS. 4A and 4B.

FIGS. 4C, 4D, 4E, and 4F are additional example embodiment graphical user interfaces showing how a user may interact with a product and advertisement in step 300 and step 310 and receive a reward in step 330. After interacting by appropriately scanning three products, the screen in FIG. 4C may disappear and the game result with appropriate functionality unlocked in step 320 and step 330 as shown in FIG. 4D. Alternatively, the user may interact by scanning a receipt indicating purchase in response to an interactive advertisement, as shown in FIG. 4E. In some instances a user may incorrectly perform the desired interaction. One example is shown in FIG. 4F, where the user has scanned the wrong barcode, resulting in no reward being provided to the user (step 325).

Example methods may utilize third party interfaces to achieve interactions. For example, an interaction presented on a user device may request a user “check-in” on a social networking service at an advertised location or location providing an advertised service or product. The check-in option may be displayed as a single button provided by the social networking service via a third party application programming interface or software development kit, web interface, or the like. The check-in option may be presented alongside the advertisement. In some aspects, the third-party may provide verification information back to the interactive advertisement, network, advertising provider, application provider, or the like. For example, the social networking service may receive a signal indicative of the “check-in” and may return verification information indicating that the check-in occurred at a permissible or valid location. This may include the social networking service using GPS/Wi-Fi location verification provided in the check-in signal to the social networking service. As discussed above, in some aspects the interactive advertising provider, the user device, another device or party, or any other party capable of receiving data including geographic location information may be tasked with verifying a location of a device or a locative aspect of the completion of the interaction. For example, the user device may determine its location and compare the location against a list of acceptable or unacceptable locations, coordinates, or the like. As another example, the user device may transmit geolocation data to the interactive advertising provider or another party or device for further processing and/or verifying.

A single or multiple parties may control, cause, or direct each action of various aspects described herein. For example, a specially programmed or hardware-configured user device may execute the presenting step 300, receiving input step 310, verifying input step 320, and rewarding step 330 or not rewarding step 325 the user based on the same. Such configuration or programming may be through an application download and installation and/or provided natively in the device or operating system. For example, an application running on a user device may display an interactive advertisement, receiving interaction input through its camera or another sensor, and may verify the input, through previously-provided verification parameters and/or image analysis software, and—as a reward—remove the advertisement if the input verifies as successful completion of a requested interaction.

In some aspects, all of the information, parameters, rewards, or the like, such as the verification parameters, may be provided as part of the application. This may allow for presenting advertisements, receiving input responsive to such advertisements, and verifying the input in situations where a network connection or capability is unavailable, slow, weak, or the like. Results may be transmitted to an advertising provider or other party at a later point when connectivity is enabled, strengthened, faster, restored or the like, and new interactive advertising content may be retrieved from a provider when such connections become available for use. Results may be transmitted in this matter for analysis and tracking purposes, such as to facilitate methods using responsive and targeted advertisements.

An application provider and/or an interactive advertising provider may each wholly or partially provide devices or system according to aspects described herein. In terms of the actors of the example network of FIG. 1, an application provider 50 may include interactive advertisements in functionality or one or more applications installed on user devices 20, and through communication to device 20, may present interactive advertisements on user device 20. Application provider 50 may further receive input by user 1 through device 20 in response to the advertisements, and application provider 50 may verify and potentially reward the user based on the received input. Or, for example, interactive advertising provider 100 may perform all these actions through communication with user devices 20. In the instance that an example method is fully or partially executed by a party different from the advertising provider 100, the advertising provider 100 may still provide advertising, reward, and/or verifying content to the executing party.

Still further, different actions of example methods may be performed by different providers. For example, the advertising provider 100 may provide application providers 50 with a software development kit or application interface through which application providers 50 may add programming or other components to their applications to execute one or more aspects described herein on user devices 20. When the application is executed by the user device 20, an interactive advertisement may be performed as part of the application. User input of a requested interaction may be sent to the advertising provider 100 for verification, and, upon successful verification, the application provider 50 either itself or an application on device 20 may provide an appropriate reward. In such a scenario, handshakes between various providers and user devices, potentially based on known authentication protocols, may be implemented to provide for proper content presentation in step 300, proper input routing in step 310, reliable verification and results providing in step 320, and trustworthy reward assignment in step 330, potentially among several different servers and user devices controlled and operated by mutually exclusive or overlapping parties.

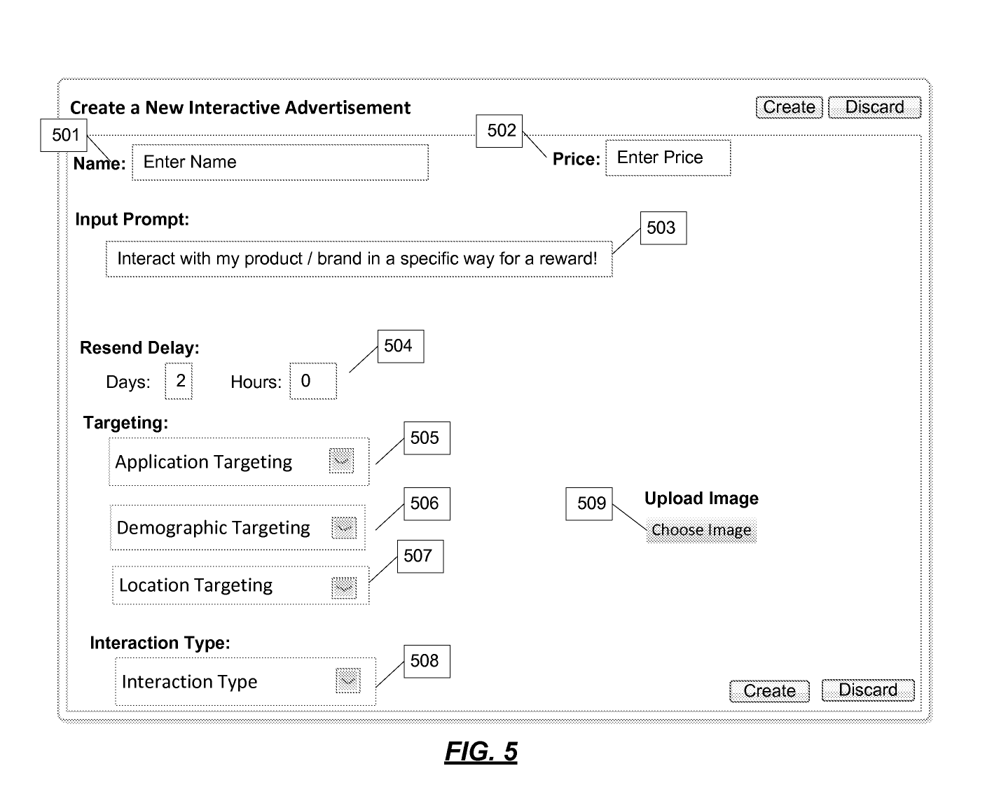

FIG. 5 illustrates example methods of the disclosure in the context of a user interface for creating interactive advertisements. In some aspects, the advertising provider 100 may provide individuals or organizations with a software development kit or application interface through which individuals or organizations can create interactive advertisements. One example interface may be a graphical website such as that depicted in FIG. 5. An advertiser may enroll on the website and create one or more interactive advertisements. As depicted in FIG. 5, the advertiser may be provided with one or more input controls such as a name control 501, a price control 502, a prompt control 503, a resend delay input control 504, an application targeting control 505, a demographic targeting control 506, and a location targeting control 507. Additionally, the advertiser may be provided with interaction control 508. The above controls are exemplary and other controls not shown in FIG. 5 may be provided. In some aspects, the advertiser or interactive advertisement creator may be provided with a graphical user interface representing an environment in which the advertiser or interactive advertisement creator may “drag and drop” elements or components into a screen, interactive advertisement, container, or the like. For example, an advertiser may be provided with a “What You See Is What You Get” (WYSIWYG) style editor or creation tool in which to create one or more interactive advertisements or components thereof.

Using the name control 501, the advertiser may input the name of the advertisement, and using the price control 502, the advertiser may input the price per successful user interaction by the user of the user device 20 with the advertisement. Different advertisements may have different value, depending on the interaction performed by the user. For example, answering survey questions may be of less value than scanning a receipt indicating purchase or acquisition of the product, as the latter may indicate that the user has actually purchased the product (e.g. the advertisement was a success). The advertiser may wish to bestow on the purchaser or acquirer of the product a greater reward than the user who answers survey questions. In some embodiments, the price the advertiser may be willing to pay may be variable depending on time, location, demographic, application, or the like. For example, the advertiser may wish to generate “buzz” by providing a higher-value reward at the beginning of the campaign; every user who successfully completes the sought-after interaction within the first three days of the launch of the campaign will receive a bonus. After the first three days have elapsed, the advertiser may wish to no longer provide the bonus. As another example, the advertiser may wish to associate itself with late-evening (or early-morning) revelers; the advertiser may create a bonus window where interactions between 10 p.m. and 2 a.m. are more highly rewarded than those from 2 a.m. to 10 p.m. In some embodiments, the advertiser may desire a period of time between a user's successful completion of the interaction in the interactive advertisement and a subsequent presentment of the same interactive advertisement to the same user, so as to balance the number of unique impressions (e.g. maximize the number of unique users who see the advertisement) against the number of loyalty impressions (e.g. maximize the number of interactions among repeat purchasers or users of the item being advertised). A resend delay input control 504 may therefore be provided for the advertiser to input the amount of time between completion of the interaction, and the subsequent transmission or display of the same interactive advertisement to the advertised-to user.

The advertiser may choose to target the interactive advertisement based on various profile information such as the demographic information of the advertised-to user, the application used by the user, or the geographic location of the user. The advertiser may use the application targeting control 505, demographic targeting control 506, and/or the location targeting control 507 to achieve this targeting.

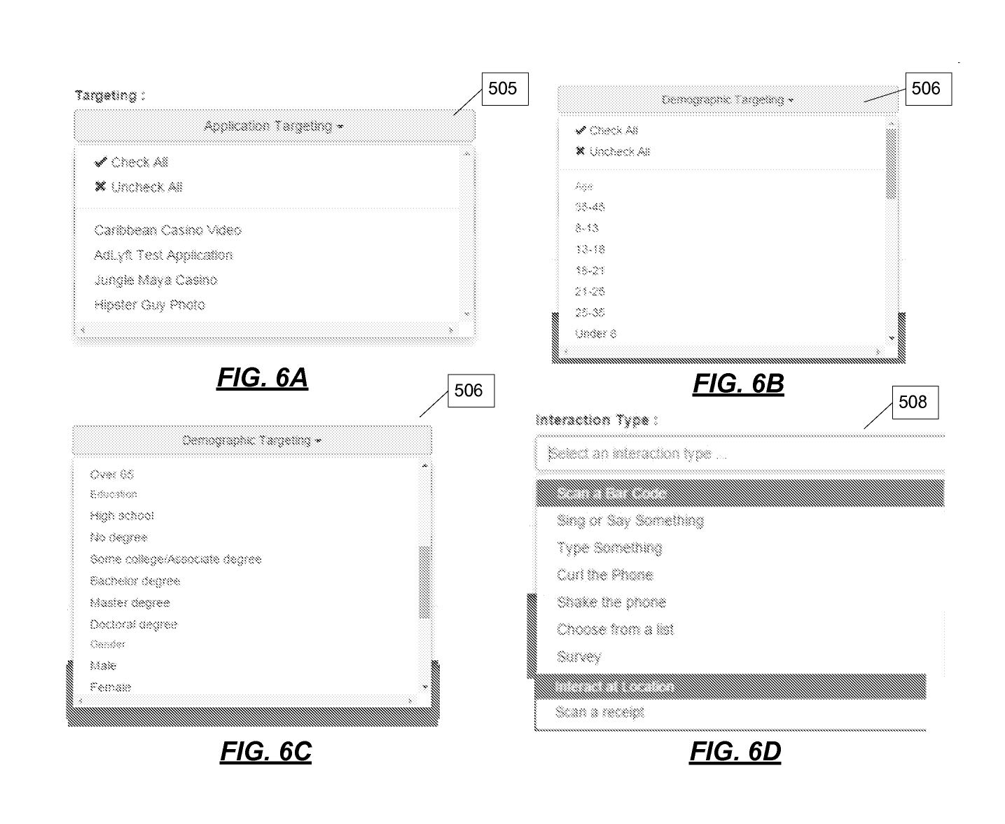

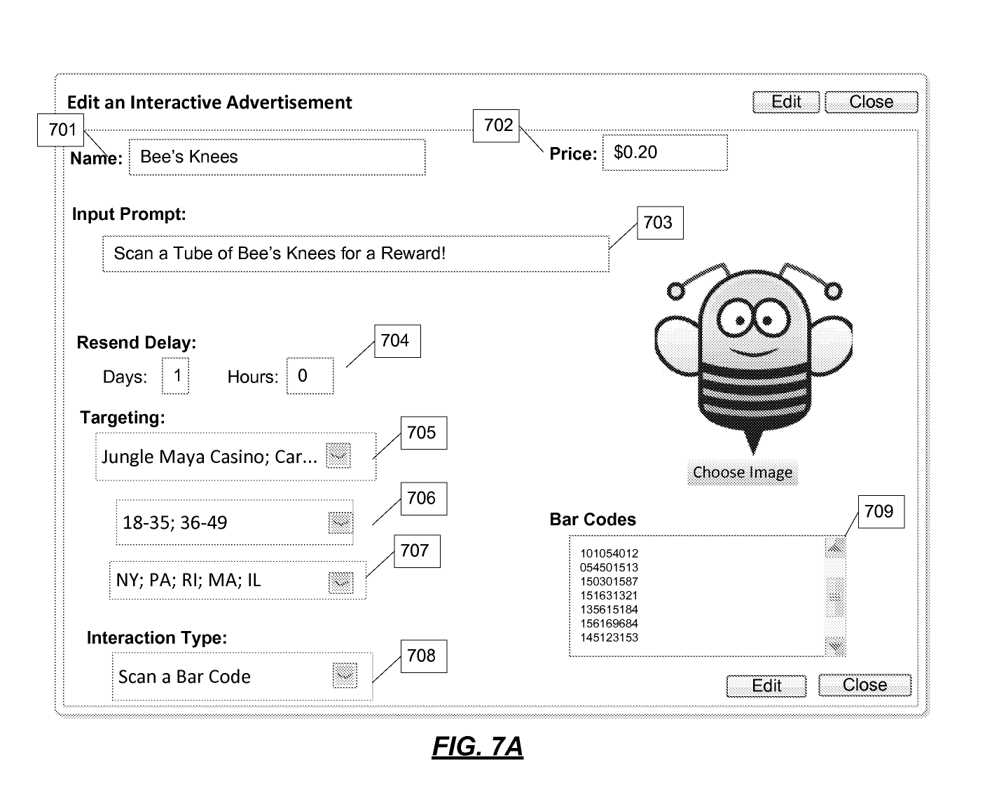

FIG. 6A shows one potential embodiment of the application targeting control 505. For example, the advertiser may select one or more applications, or criteria related to applications to achieve application targeting. For example, an advertiser for a professional social networking website may wish to target business and news applications, whereas a sugary breakfast cereal advertiser may wish to target games, whereas a healthy breakfast cereal advertiser may wish to target fitness or health-monitoring applications. In some embodiments, the advertiser may target one or more specific applications.

FIGS. 6B and 6C show some potential embodiments of the demographic targeting control 506. The demographic targeting control 506 allows the advertiser to select one more demographic criteria related to the advertised-to user. In some embodiments, the application providers 50 may provide demographic information to interactive advertising provider demographic information via the software development kit, software interface, or other data communications. In some embodiments, the advertising provider 100 may provide all or a subset of interactive advertisements to the application provider 50, and include data and/or meta-data related to the demographic targeting of the advertisements. This may enable the application provider 50, or a module of the software development kit or software interface of the application operating on the user device 20, to select from the advertisements based on the demographic information known or available to the module or the application provider. Demographic information may include, for example, age, gender, income, education, or the like. In some aspects, the advertiser may be able to select one or more predefined groupings within a demographic classification. For example, the advertiser may select 18-34 year olds and 45-54 year olds but may opt not to select 35-44 year olds. In some embodiments, the groupings may be dynamic based on other selections and/or inputs, including those provided by the advertiser in the graphical website. For example, the advertiser may input using the application targeting control 505 a casino gaming application. Because some jurisdictions may limit gambling to those over 21 years old, the available options in the demographic targeting control 506 may change dynamically to provide a 21-34 year olds demographic grouping, or making non-selectable or non-inputable groupings comprising users below 21 years of age. As another example, the advertiser may be advertising an alcoholic beverage and may wish to target individuals who have reached the legal age of consumption in a targeted location.

As such, one or more targeted locations may be inputted using the location targeting control 507. In some embodiments, the advertiser may be able to directly select geographic jurisdictions or regions (e.g. by state, by zip code, by area code, by county, by congressional district, or the like). In some embodiments, the advertiser may be able to select geographic jurisdictions or regions according to a parameterized filtering mechanism (e.g. zip codes where average home values exceed a certain dollar figure, shopping malls with a certain department store, all locations within a radius of a restaurant, or the like). Selectable options which may be presented in the location targeting control 507 may change dynamically depending on one or more inputs or selections, including those input elsewhere in the dynamic website of FIG. 5.

In some aspects, location interactions may take the form of the user device 20 interacting with one or more external devices to determine location, such as determining the location via GPS, beacon, cellular triangulation, other location services, or the like. Location based interactions may take the form of a user using an application of the user device 20 to “check in” to a location. Locations may therefore be incorporated into the valuation of completion of an advertisement. For example, if a user scans a box of cereal at home, the user may receive a small reward. If the same user scans the same box of cereal at a grocery store or supermarket, it may indicate an opportunity for an advertiser to influence purchase of the box of cereal, and therefore a user may receive both a larger reward than scanning the box at home and a coupon or other discount to purchase the cereal. In some embodiments, for example where certain location services are difficult to implement (e.g. GPS indoors), location services may be provided by the application provider 50 and/or the advertising provider 100 by deployment of beacons, near-field communication (NFC) devices, or the like to provide location interactions.

Other types of targeting, in addition to or in the alternative to the examples presented in FIG. 5, are possible. For example, the advertising provider 100, the application provider 50, or other interested individuals and/or organizations, may determine, store, or track interest information associated with a user of the user device. This interest information may be related to one or more interests, such as hobbies, pursuits, sports, games, focuses, or the like. For example, an interest may be broad, such as “fashion,” or narrow, such as “shoes with red soles.” Of course, broader and narrower interests are possible. These interests may be user-input, or may be inferred from one or more previous interactions, purchases, survey answers, geolocations, or the like. Advertising may be selected for transmission to the user device associated with the targeted user based on one or more interests. As an example, a user interested in “shoes” may receive an interactive advertisement created for a footwear company, whereas a user interested in “basketball” may receive a different interactive advertisement created for the same footwear company featuring a basketball shoe or depicting a basketball player.

In some aspects controls may be provided on a “campaign” basis. A campaign may include one or more advertisements, and controls may be provided to reflect inputs or settings common to the one or more advertisements included in the campaign. For example, a demographic targeting control may be provided to control input which may provide input and/or control of multiple advertisements. For example, the advertiser may select 18-34 year olds and 45-54 year olds but may opt not to select 35-44 year olds using a campaign demographic input control, reflecting that multiple advertisements within the campaign may be targeted toward 18-34 year olds and 45-54 year olds. As discussed above, the groupings or options within a campaign-based control may be dynamic based on other selections and/or inputs, including those provided by the advertiser in the graphical website. In some embodiments, both a campaign control and an advertisement-specific control may be provided, with input to one control taking precedence over input to the other control. For example, the advertisement-specific input may take precedence over the campaign input. A rule regarding precedence may be defined by the advertisement or campaign creator, the interactive advertising provider, or other party, individual, organization, process, device, or the like.

FIG. 6D illustrates one potential example of the interaction control 508. The interaction control 508 may be provided to enable the advertiser to select one or more interactions to be performed by the advertised-to user. Non-exhaustive examples of potential interaction types are shown in FIGS. 6E and 6F; for example, the user may be asked to scan a barcode, sing or say a phrase, type something using a keyboard of the user device 20, curl the phone as if lifting a barbell, shake the phone, choose from a list of random or predetermined options, answer one or more survey questions, interact with the user device or a physical object at a location, or scan a receipt, or the like. Other interaction types may be input by the advertiser or the advertising provider. For example, in some instances a logo of a company may have a distinctive shape (e.g. a letter such as the letter ‘M’). An inputable interaction may be a user moving the user device 20 in an ‘M’ shape.

Interactions may be chained to provide a “treasure-hunt” style effect to the end user. In another example, a first reward may be provided to a user for checking into a location, such as a clothing store. Once the check in has occurred, the advertising provider 100, and/or the application provider 50 may then notify the user that a certain item in the clothing store is on sale and they will get another reward for locating and scanning the item. Scanning the barcode of the certain may trigger a third interactive advertisement, in which the user may be asked what color the item is for a third reward. The user may speak the color of the item to receive the third reward, then they may be presented with a survey about the store/staff for a fourth reward, then they may then be told that if they purchase this/any item from the store, they will receive a fifth (and largest) reward from scanning the receipt. Interactions/prompts can be chained in other ways as well, this is just one example.

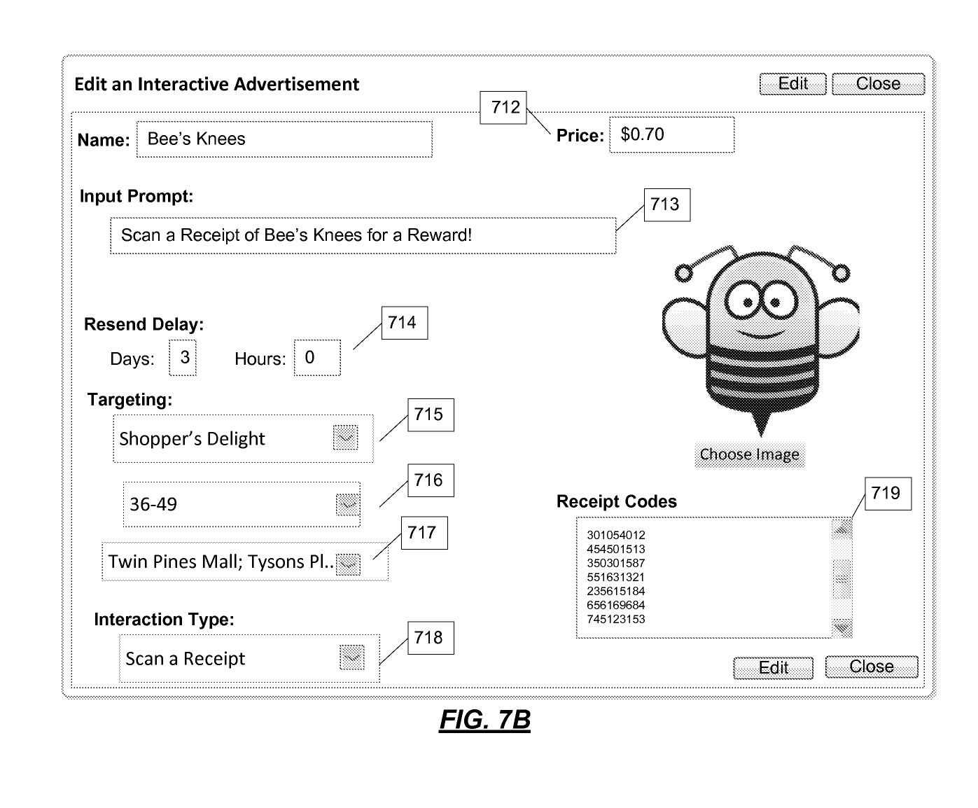

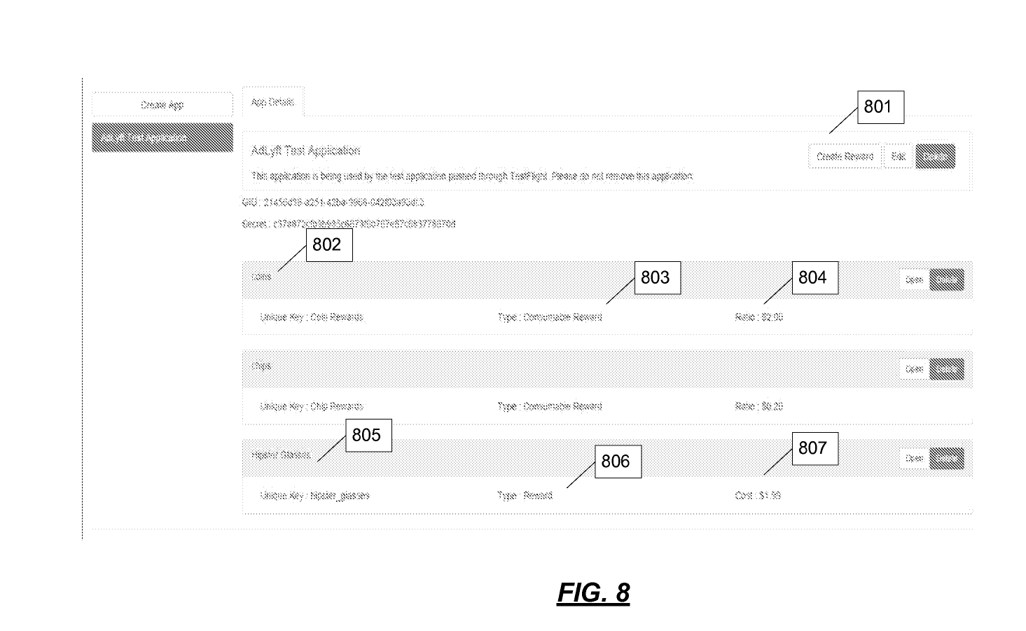

FIG. 7A illustrates an example usage of the graphical website to create an interactive advertisement. As can be seen, the advertiser has input a name for the advertisement “Bee's Knees” using the name input control 701, input a price of $0.20 per user-completed interaction using the price input control 702, and input a prompt to the user using input prompt input control 703. The advertiser has also input a one day resend delay using the resend delay control 704. The advertiser is targeting at least a “Jungle Maya Casino” application inputted via the application targeting control 705, age groups 18-35 and 36-49 inputted using the demographic targeting control 706, and users in the states of New York, Pennsylvania, Rhode Island, Massachusetts, and Illinois via the input in the location targeting control 707. The advertiser has selected at least the “scan a bar code” interaction via input in the interaction control 708. Based on this selection, the advertiser has also input several bar codes in bar code control 709. As discussed above, the user will be rewarded approximately $0.20 of value upon successfully scanning a bar code comprising one of the bar codes listed in the bar code control 709.

FIG. 7B illustrates another example of input by an advertiser using the graphical website of FIG. 5. This example differs from FIG. 7A in that the advertiser desires a “scan a receipt” interaction, as shown in the input to interaction control 718. The created interactive advertisement of FIG. 7B also differs from FIG. 7A in the price input (712), input prompt input (713), resend delay input (714), targeted application input (715), and targeted demographic input (716) using the appropriate controls discussed above with respect to FIG. 5. Additionally, the advertiser is targeting shopping centers via the input to the location targeting control 717, either in addition to or in lieu of the states or regions shown as input to the location targeting control 707. Furthermore, in addition to or in lieu of the bar codes in the bar code control 709, several receipt codes have been inputted into a receipt code control 719. As discussed above, the user will be rewarded approximately $0.70 of value upon successfully scanning a bar code comprising one of the bar codes listed in the bar code control 709.

In some aspects, inputs to the various controls illustrated in FIGS. 5-7 may be inputs resulting from one or more specially-programmed computing devices. The input may be responsive to a determination that an interactive advertisement targeting a specific application, specific demographic, specific location, and/or utilizing an interaction is desired. For example, the advertiser, the application provider 50, or the advertising provider 100 may operate one or more processing devices specially-programmed to determine one or more under-targeted applications, demographics, locations, and/or under-utilized interactions and may programmatically create an interactive advertisement to target the application, demographic, location, and/or use the interaction. For example, a computing device may determine that 18-24 year old users of a fitness application are not receiving interactive advertising. As a result, an interactive advertisement using a “curl the user device like a dumbbell” interaction may be programmatically created to target such users. In some embodiments, metrics may be collected or analyzed relating to the price, quantity, targeted applications, targeted demographics, targeted locations, use of interactions, or the like and presented to the advertiser, the application provider 50, or the advertising provider 100 via a report. The report may be delivered on a predetermined schedule, upon request, or via an interactive dashboard, for example as part of the example graphical website interface. FIG. 8 illustrates another example section 801 of the example graphical website interface introduced in FIG. 5.

In FIG. 8, application developers, such as the application provider 50, may input various rewards offered in their applications. These rewards may include one-time rewards, such as a set of “hipster glasses” 805, and the rewards may include consumable rewards such as the “coins” 802. One-time rewards may be provided to a user of the user device 20 a single time because the reward has a permanent or long-lasting effect (e.g. the user is able to outfit a character with the set of “hipster glasses”), whereas consumable rewards may be offered repeatedly because they may be used frequently during usage of the application. For example, coins may be an in-application currency frequently depleted during usage of the application (e.g. slot machine spins, speeding up a build cycle, or the like). Application developers may indicate the type of reward using input controls similar to those discussed above with respect to FIG. 5, resulting in example types 803 and 806. Application developers may indicate the value of the reward using input controls resulting in ratio 804 (for the consumable reward coins 802) and price 805 (for the one-time reward hipster glasses 805). A user's receipt of a reward 802 or 805 may be based on their completion of one or more interactions having total value approximately equal to the ratio 804 or price 805. Additionally or alternatively, the ratio may reflect the number of consumable units to be received per unit of value. For example, a user may receive coins 802 if they complete one or more advertisements at a ratio of 2.0 coins per 1 cent of advertising value; with this example, a user completing an advertisement having 45 cents of value to an advertiser may receive 90 coins. Other methods of providing both one-time rewards and consumable rewards are possible; for example, there may be a predetermined threshold. For example, a user may not receive any of a consumable until a certain value of completed advertisement interactions has been achieved, and then may receive the consumable reward at the ratio 804. As another example, a user may “cash in” completed advertising interaction values at static or variable ratios. A user may have 10 units of advertising value accumulated and may exchange all or a portion of this at a first ratio. The user may also elect to save the 10 units (or a portion thereof) and wait until 20 units have been accumulated so that the user can exchange at a different ratio. Of course, in addition to the second threshold having a second ratio, there may be one or more additional thresholds at one or more additional thresholds.

A non-consumable or consumable reward may have a set or variable price greater than or higher than the value earned by the user for completing any one individual interactive advertisement, and interaction with multiple advertisements may be required to achieve the price of the reward. Users may accumulate value by completing multiple interactions advertisements with a goal of eventually “unlocking” the reward or achieving the price of the reward. As discussed, this reward may include the removal of other advertising or other advertising systems or the like, access to premium content for a time period or on a permanent basis, premium features for a time period or on a permanent basis, or the like.

In some aspects, the interactive advertising provider may provide ads to the user with a value exceeding the amount required to “unlock” the reward. For example, a reward may cost two dollars ($2.00) and one or more advertisements may have been interacted with by the user to achieve an accrued value of $1.95. The user therefore may desire only five more cents to “unlock” the reward. The interactive advertising provider, user device, provider, or other party may serve or provide an interactive advertisement to the user (via the user device) in excess of five cents. The excess value may be retained by the interactive advertising provider, offered to the user, offered to the developer, donated to a charitable organization, or the like.

Interactions, interactive advertisements, and opportunities to present interactive advertisements may span multiple advertisers or multiple user devices. In another example of an arrangement of the application provider 50, advertising provider 100, advertising organizations, and the user device 20, the interactive advertising provider may act as a central “hub” to facilitate multiple-organization interactions. For example, several applications on the user device 20 or applications on multiple user devices 20 may include one or more components of the software development kit and/or software interface facilitating the delivery of the interactive advertisements discussed above. The user device may enter a geolocation zone (e.g. “geofence”) where two or more of the applications have potential interactions. For example, the user and the user device 20 may enter a shopping mall, “triggering” potential interactions to receive rewards in a business application, a fitness application, and a gaming application. In some embodiments, the user device 20 may receive notifications for all three potential interactions. In other embodiments, the user may be notified via the user device 20 only regarding a subset (one or two in this example) of the potential interactions. A computing device (e.g. the user device 20, and/or one or more devices associated with the application provider 50 or the advertising provider 100) may determine which application and/or triggered potential interaction should be presented to the user. In some embodiments, this may be based on how frequently the user interacts with the application (e.g. because of loyalty, a more frequently used application may be a better candidate; to re-spark interest in the application, a less frequently used application may be a better candidate), a determination as to the existence of potential agreements between the application provider and the location (e.g. a check-in at the clothing store may result in a notification of an interaction in an application affiliated with the clothing store), or the like. To continue with the discussion of “cashing in” value discussed above, in some aspects it may be possible to accumulate value across multiple interactive advertisements presented in multiple applications. Advertising value may be fungible and moveable across the applications and/or to the central “hub” for rewarding or cashing in. As one example, a user may move acquired value from interactive advertisements completed in the context of a puzzle gaming application, where the user has completed all the levels of the game or no longer enjoys playing the puzzle game, to a new vehicle racing game to unlock more quickly vehicles or vehicle components. As another example, the user may move the acquired value to an application acting as an interface to the central “hub” where it may be exchanged for non-application-specific rewards, or rewards offered by an advertiser, third party, or the like.

As another example of interactive advertising provider potentially acting as a central “hub” to facilitate multiple-organization interactions, a user may download or install an interactive application or other software provided by the interactive advertising provider on multiple user devices. As an example, a user may install an application or other software for operation on two or more of a personal computer, a tablet, a television set-top box, a device adapted for streaming of content such as movies or music, a gaming device, a mobile device, or the like. A user may encounter an advertisement with an interactive advertisement interaction on one device, and may complete the interaction using a second device. For example, the user may be streaming or viewing a movie using a first device (e.g. a set-top box) and encounter an advertisement similar to those discussed above. The user may complete the interactive advertisement using the second device (e.g. a mobile device). For example, the user may be presented with an interactive advertisement on a screen where the movie is being presented with an interaction goal of speaking the word “marmalade.” The first device may lack capabilities to receive a sound signal. The user may elect therefore to speak the word “marmalade” so that it is captured by a microphone of the second device. The second device may verify the correct word was spoken and transmit a signal indicating verification of the interaction to the first device, interactive advertising provider, or other device and/or party. Additionally or alternatively, the second device may transmit a signal or data indicative the recorded word to the first device, interactive advertising provider, or other device and/or party for verification. Successful completion of the interaction may be communicated to the user, for example, by removal of the “marmalade” interactive advertisement from the screen and/or commencement or recommencement of the movie.

Users may, via a “hub” application installed on one or more of the user devices, log into, associate, or affiliate one or more partner applications and/or websites through the application, a web portal, user interface, or the like. For example, a user may log in or associate one or more third-party accounts, such as social media accounts, social networking accounts, food vendor accounts (e.g. an account with a pizza restaurant or chain), a content account (e.g. an account providing or facilitating access to content such as streaming media), a utility account (e.g. electricity, telecommunications, water, gas) or any other account, with the interactive advertising provider and/or the application, or an account thereof. Users may interact with or experience advertisements appearing in applications or in content appearing on the user devices (e.g. web pages appearing in a web browsing application. The content application or applications may handoff advertisement opportunities with user interaction to the hub application, which may provide an interactive advertisement including an interaction to the user, and may verify completion of the interaction. For example, a web browsing application may present a modal window disallowing usage of the web browsing application until an interaction is completed. As another example, the web browsing application, hub application, or operating system may cause the application running in the foreground to “switch” from the web browsing application to the hub application. The user may return or switch back to the web browsing application upon successful completion of an interaction present in an interactive advertisement.

Having a central location for users to associate their other accounts may facilitate the removal of intrusive or undesired advertising from experiences or content associated with those accounts. For example, as discussed above, commercials may be removed from streaming media experiences, or utility companies may be signaled so as to credit the user's account with discounts or additional bandwidth, space, storage, or the like as a reward. A centralized service may also allow for tracking of rewards, progress toward rewards, and reminders when appropriate. For example, a user may be reminded via one or a plurality of devices or content appearing on devices to complete an interaction, such as checking in at a geolocation, to retain free, subsidized, advertising-free, or discounted service or access to content from a content provider. An installed hub application on a device and/or a centralized service may also act to limit or manage notifications, for example, to avoid user frustration or interactive advertising satiation. Notifications, including reminders discussed above, may be managed more effectively, updated more frequently, and facilitate deeper linking to content within other applications. As an example, the interactive advertising provider may have a partnership agreement with a discount clothing store. The user may be in a location near to the discount clothing store, and may receive notifications indicating sales or promotions ongoing in the discount clothing store on a user device. The user may also receive a link to an application affiliated with the discount clothing store, or the application may be instantiated, brought to the foreground, installed on the device, or the like. Upon installation, bringing to the foreground, instantiation, or the like, the hub application or centralized service may facilitate or otherwise cause, within the affiliated application, the appearance of a specific item such as an item promoted or on sale.

Another potential multi-advertiser interaction may be as follows. A user may interact with the user device 20 and associate one or more third-party subscription services (e.g. a streaming video service, a periodical subscription, a website subscription, data provider, cellular telephone provider, utility company, or the like). The user may receive a reward extending or enabling their participation in the third-party subscription service for completing an interaction. In some embodiments, this interaction may be an interaction for a different advertiser than the third-party subscription service. For example, a user may check-in and purchase coffee at a coffee shop twice a week. These interactions may be verified and their successful completion may result in the user being enabled to view newspaper articles on a subscription-based newspaper website on a complimentary basis. In another example, a user may scan a soft drink and receive some number of minutes of commercial-free viewing on a streaming video service, where the user would have had to watch commercials had she not scanned the soft drink. In some embodiments, access to the third-party subscription service may be disabled or discontinued if the user does not complete interactions successfully in a predetermined or dynamic time period. For example, the user's complimentary access to the subscription-based newspaper website may be discontinued if the user does not “check in” at the coffee shop twice a week.

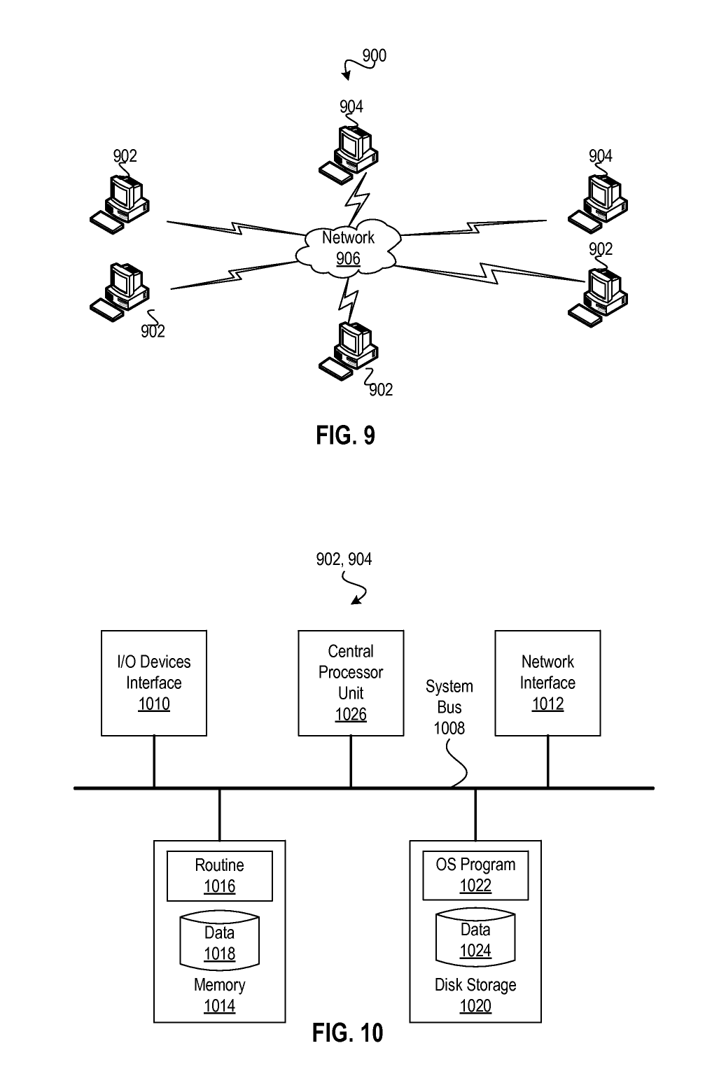

In FIG. 9, an example of an implementation of a computing environment 900 in which aspects of the present disclosure may be implemented is shown. Client computing devices 902, which may be user devices or interactive advertising creation devices, and server computing devices 904 provide processing, storage, and input/output devices executing application programs and the like. Client computing devices 902 may include, e.g., desktop computers, laptop computers, tablet computers, palmtop computers, smartphones, smart televisions, and the like. Client computing devices 902 can also be linked through communications network 906 to other computing devices, including other client devices computing devices 902 and server computing devices 904. Communications network 906 can be part of a remote access network, a global network (e.g., the Internet), a cellular network, a worldwide collection of computers, local area or wide area networks, and gateways that currently use respective protocols (TCP/IP, Bluetooth, etc.) to communicate with one another. Other electronic device/computer network architectures are suitable.

In FIG. 10, a block diagram of one of the computing devices 902 or 904 of the computing environment 900 of FIG. 9 is shown. The computing device 902 or 904 contains system bus 1008, where a bus is a set of hardware lines used for data transfer among the components of a computing device or processing system. Bus 1008 is essentially a shared conduit that connects different elements of a computing device (e.g., processor, disk storage, memory, input/output ports, network ports, etc.) that enables the transfer of information between the elements. Attached to system bus 1008 is I/O device interface 1010 for connecting various input and output devices (e.g., keyboard, mouse, displays, printers, speakers, etc.) to the computing device 902 or 904. Network interface 1012 allows the computing device to connect to various other devices attached to a network (e.g., network 906 of FIG. 9). Memory 1014 provides volatile storage for computer software instructions 1016 and data 1018 used to implement aspects described herein (e.g., an advertising system, device, or component implementing the steps detailed above). Disk storage 1020 provides non-volatile storage for computer software instructions 1022 and data 1024 used to implement various aspects of the present disclosure. Central processor unit 1026 is also attached to system bus 1008 and provides for the execution of computer instructions.

In one aspect, the processor routines 1016 and 1022 as well as data 1018 and 1024 are a computer program product, including a computer-readable medium (e.g., a removable storage medium such as one or more DVD-ROM's, CD-ROM's, diskettes, tapes, etc.) that provides at least a portion of the software instructions for implementing aspects of the present disclosure. The computer program product can be installed by any suitable software installation procedure, as is well known in the art. At least a portion of the software instructions may also be downloaded over a cable, communication and/or wireless connection. Computer-readable media include all computer-readable media but do not include transitory propagating signals.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a markup language such as (but not limited to) HTML or XML. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects, and such data structures are contemplated within the scope of computer executable instructions and computer-usable data described herein.

While aspects have been particularly shown and described with references to example embodiments thereof, it will be understood that various changes in form and details may be made therein without departing from the scope and spirit identified by the appended claims.

What is claimed is:

1. A method comprising:
presenting, by a user device, an interactive advertisement comprising: a request for performance of at least one interaction by a user of the device with a physical object associated with the interactive advertisement, and an indication of at least one reward for completion of the at least one interaction;
receiving, via the user device, input responsive to the indication, wherein the input indicates the user has performed the at least one interaction; and
verifying the input satisfies the at least one interaction.

2. The method of claim 1, further comprising:
rewarding the user with the at least one reward if the verifying determines that the input satisfies the at least one interaction.

3. The method of claim 2, wherein rewarding the user comprises at least one of granting additional functionality on the device, permitting access to rights-controlled content through the device, granting a discount on a product in the interactive advertisement to the user, applying a change to an account of the user.

4. The method of claim 2, wherein the interactive advertisement is presented during an operation of an application by one or more processors of the user device, and rewarding the user with the at least one reward comprises signaling to the application to add a reward to an account of the user associated with the application.

5. The method of claim 2, further comprising:
loading, on the user device, content of the advertisement prior to the presenting; and
transmitting, with the user device, a result of rewarding the user to an advertising provider.

6. The method of claim 1, further comprising:
punishing the user if the verifying determines that the input does not satisfy the at least one interaction.

7. The method of claim 1, wherein receiving the input comprises receiving input from a sensor of the user device.

8. The method of claim 1, wherein verifying the input comprises determining a location associated with the user device or with the input.

9. The method of claim 1, wherein verifying the input comprises receiving a verification signal from a third-party provider based on the input.

10. The method of claim 1, wherein the verifying comprises comparing the input against a list of acceptable inputs or a list of previously-received inputs.

11. A method comprising:
presenting, on a display, one or more input controls comprising an interaction input control;
receiving, by a computing device, input via the one or more input controls, the input comprising an advertised subject matter;
creating, responsive to the input, an interactive advertisement comprising a required interaction with the advertised subject matter; and
transmitting, by the computing device, the interactive advertisement to a user device associated.

12. The method of claim 11, further comprising:
receiving, by the computing device, a completion signal indicative of a user completing the interaction with the advertised subject matter; and
transmitting, responsive to receiving the completion signal, a reward signal triggering a reward associated with the user.

13. The method of claim 11, wherein receiving input via the one or more input controls comprises receiving a selection indicative of the interaction.

14. A method comprising:
delivering, to a user device, one or more instructions configuring the user device to:
present an advertisement including at least one requested interaction by a user of the user device, the interaction to be performed by the user with the user device;
receive input as proof of the requested interaction; and
provide a notification of a reward when the input satisfies the requested interaction.

15. The method of claim 14, further comprising:
verifying the input satisfied the requested interaction.

16. The method of claim 15, wherein verifying that the input satisfied the requested interaction comprises:
receiving visual input of a product from the user device; and
determining the visual input comprises a representation of a specific three-dimensional physical product.

17. The method of claim 16, wherein receiving visual input comprises receiving input via a camera of the user device.

18. The method of claim 16, wherein the visual input comprises a video format and wherein determining comprises analyzing the visual input for screen flicker.

19. The method of claim 15, wherein the input comprises a signal indicative of audio information, and wherein verifying the input comprises comparing a portion of the signal with a signal associated with the requested interaction.

20. The method of claim 15, wherein the input comprises data indicative of movement of the user device, and wherein verifying the input comprises determining a portion of the data indicates a predetermined shape.
